(19) United States
(12) Patent Application Publication
(10) Pub. No.: US 2017/0131010 A1
(43) Pub. Date: May 11, 2017

(54) RECHARGING SYSTEMS AND METHODS

(71) Applicant: HONEYWELL INTERNATIONAL INC., MORRIS PLAINS, NJ (US)

(72) Inventors: Samuel F. Yana Motta, East Amherst, NY (US); Michael Petersen, Clarence Center, NY (US); Elizabet del Carmen Vera Becerra, Amherst, NY (US); Ankit Sethi, Buffalo, NY (US); Gustavo Pottker, Amherst, NY (US)

(21) Appl. No.: 15/287,250

(22) Filed: Oct. 6, 2016

Related U.S. Application Data
(60) Provisional application No. 62/238,416, filed on Oct. 7, 2015.

(51) Int. Cl. F25B 45/00; C09K 5/04

(52) U.S. Cl. CPC F25B 45/00; C09K 5/045; C09K 2205/40; C09K 2205/22; C09K 2205/126; C09K 2205/122; F25B 2500/09

(57) ABSTRACT

Disclosed are methods of recharging an operating system of the type containing a less than full charge of existing working fluid with a recharging fluid that is different than said existing fluid, the method comprising: (a) identifying at least one readily measured physical property of fluids comprising combinations of the existing working fluid and the recharging working fluid wherein said physical property reliably correlates to target component concentrations of the working fluid after recharge; (b) providing a system which contains less than a full charge of the existing working fluid; (c) adding to the existing working fluid a recharging fluid having at least one property superior to that property of the existing working fluid; (d) at least after said adding step (c), measuring said readily measured physical property of the operating fluid in the system; and (e) based on said measuring step, repeating or not said steps (c) and (d) and/or adjusting at least one system operating parameter.

### CROSS REFERENCE TO RELATED APPLICATIONS

This application claims priority to U.S. provisional application Ser. No. 62/238,416, filed Oct. 7, 2015, which is incorporated herein by reference.

### FIELD OF THE INVENTION

This invention relates to improved systems and methods for recharging systems of the type containing a fluid which is involved in carrying out operations, such as heat transfer operations and solvent cleaning operations that involve a periodic need to add replacement fluids to the system to form an environmentally improved system. The present invention also relates to the recharged systems.

### BACKGROUND

Many systems that contain one or more fluids are involved in carrying-out important operations, frequently by circulating and/or otherwise using the fluids in the system. As a result of being so involved in the system operation, it is frequently required that the fluid will leave the system, either by accident (such as would occur as a result of unintentional leakage) or intentionally (because the fluid has lost a desired level of effectiveness). For example, mechanical refrigeration systems, and related heat transfer devices such as heat pumps and air conditioners, use refrigerant liquids that circulate in the system and provide heating or cooling for industrial, commercial and domestic uses.

Certain fluorocarbon based fluids have found widespread use in many residential, commercial and industrial applications, including as the working fluid in systems such as air conditioning, heat pump and refrigeration systems and in solvent cleaning operations. Because of certain suspected environmental problems, including the relatively high global warming potentials associated with the use of some of the compositions that have heretofore been used in these applications, it has become increasingly desirable to use fluids having low or even zero ozone depletion and global warming potentials, such as certain hydrofluorocarbons (“HFCs”). For example, a number of governments have signed the Kyoto Protocol to protect the global environment and setting forth a reduction of CO₂ emissions (global warming). Thus, there is a need for a low- or non-flammable, non-toxic alternative to replace certain of high global warming HFCs.

One important type of refrigeration system is known as a “medium temperature refrigeration system.” Such systems are particularly important because they are utilized in a wide variety of applications, including domestic refrigeration, commercial refrigeration, industrial refrigeration and transport refrigeration, and are commonly used in the food manufacture, distribution and retail industries. Thus, such systems play a vital role in ensuring that food which reaches the consumer is both fresh and fit to eat. In such medium temperature refrigeration systems, a commonly used refrigerant liquid has been HFC-404A (the combination of HFC-125:HFC-143a:HFC-134a in an approximate 44:52:4 weight ratio is referred to in the art as HFC-404A or R-404A). R-404A has an estimated high Global Warming Potential (GWP) of 3943.

Solvent cleaning operations are another example of systems that operate by using a working fluid. In the case of a vapor degreaser, for example, the solvent is the working fluid that is maintained in a reservoir in a liquid phase, and a portion of the liquid solvent is vaporized to form a vapor space into which a part or article to be cleaned is introduced. As a result of these and similar operations, the amount of solvent contained in the system will frequently decrease over time as the system operates, and the system will need to be periodically recharged with solvent. Since many previously used solvents have detrimental environmental or other properties, there has been a need or desire to improve the methods of recharging such solvent systems to reduce negative environmental impact and/or to improve other properties of the system, such as to reduce the toxicity and/or flammability of the working fluid.

While it has become increasingly important to develop new, more environmentally friendly operating systems that include circulating working fluids, such as refrigerant and solvent compositions, applicants have come to appreciate that potential replacement working fluids which may have advantages from an environmental standpoint can have disadvantages, and in some cases severe disadvantages, associated with one or more of the other properties that are important for a new working fluid to be successful. For example, a proposed new, environmentally friendly refrigerant which exhibits a reduced level of capacity and/or efficiency when used in the target system frequently will cause problems not only from an operational standpoint, but also can cause secondary environmental problems that may outweigh any advantage in the GWP or ODP of the proposed new refrigerant.

Another difficulty associated with efforts to decrease the potential environmental impact of the existing, in-place working fluids, including refrigerants, has been identified by applicants. More particularly, it is known in the art that certain working systems, such as certain refrigeration systems and certain solvent systems are subject to leaking of existing working fluid in amounts of up to 50% per year. Accordingly, applicants have recognized that an improvement in the environmental properties of the existing, in-place working fluid base, including the refrigerant and solvent base, can also be associated with improved systems and methods from an operational stand-point. More specifically, the invention is directed to methods, systems and devices which provide the ability to determine with a high degree of reliability, preferably in real-time or near real-time, the concentration of the various components in the working fluid after or during the recharging operation and the ability to utilize this information to provide a system after replacement that satisfies certain target properties relating to the concentration of the components in the system after recharging has been completed and/or to provide adjustment of system parameters operating parameters in a manner that results in improved system performance and/or reliability compared to performance/reliability in the absence of such adjustments.

Applicants have found that many problems are encountered in attempting to provide such recharged systems with improved environmental properties. For example, it is frequently not feasible or desirable to remove all of the remaining fluid from the system notwithstanding that the remaining fluid possesses one or more undesirable properties, such as high GWP. Accordingly, methods of replacing an escaped working fluid with a new, more desirable (e.g., lower GWP working fluid) can produce a system that has a working fluid composition which is not the same as either the previously present (e.g., high GWP) working fluid, nor the same as the new more desirable (e.g., low GWP) working fluid with which it will be replaced. Furthermore, it is frequently not possible to know with precision the exact amount of working fluid which has escaped from the system or the amount of working fluid which remains in the system. As a result of these conditions, applicants have come to recognize that recharging such systems can produce a new operating fluid having widely varying component concentrations and that systems will likely be created containing a working fluid that has an improved property (such as lower GWP) but may unintentionally have other undesirable properties and/or unintended negative consequences on system operation and/or reliability.

Accordingly, applicants have come to appreciate the need for recharging methods, systems and devices which can efficiently and effectively, preferably in real-time or near real time, recharge the working fluid in a system to achieve a recharged system having (1) one or more target properties for operating fluid in the system after the recharge and/or (2) system operating parameters that have been adjusted to take advantage of the change in the properties of the recharged working fluid. Applicants have also come to appreciate the need for methods, systems and devices which can efficiently and effectively, preferably in real-time or near real time, adjust system operating parameters after the recharging operation has been completed or even separate from any recharge operation. Such working fluid analysis methods, systems and apparatus can be used in order to achieve improved system operation in one or more ways, including but not limited to: (1) improved operating efficiency and/or capacity; (2) bringing the operation into line with expected or necessary performance targets (for example, in the case of refrigerant systems ensuring that the amount of cooling does not result in a temperature that is too hot or too cold in the area or in the materials being cooled); and (3) ensuring that equipment limits are not exceeded.

### SUMMARY

One aspect of the present invention involves methods of recharging a working system of the type which contains an existing working fluid but which contains less than a full charge of working fluid, in which the recharging is done with a recharging fluid that is different than the existing working fluid. One goal of a recharging operation according to one embodiment, is to provide a recharged system in which the working fluid after the recharge operation has one or more improved properties, preferably at least one or more improved environmental properties, compared to the existing working fluid. Another goal is to achieve such improved environmental properties while at the same time (1) regulating the recharging operation to improve one or more other properties and/or (2) adjusting one or more system operating parameters to improve system operation and/or reliability with the recharged working fluid in place notwithstanding that the total amount of the various components in the system is different than either the existing working fluid and the recharging fluid.

Another aspect of the present invention is to provide methods, systems and apparatus for improving performance of operating systems containing a working fluid comprising:

(a) measuring a readily measured physical property of the fluid in the system that is reliably correlated to one or more component concentration(s) and/or to other property(ies) that are not readily measured physical properties of the working fluid in the system;

(b) estimating one or more component concentration(s) and/or to other property(ies) that are not readily measured physical properties of the working fluid based on said measuring step; and

(c) adjusting at least one system operating parameter based at least in part on said estimating step.

It will be understood by those skilled in the art that the estimating step described herein includes for the measured properties, utilizing experimental data to establish the ability to correlate the value of the measured property with component concentrations. It is contemplated that those skilled in the art will be able to determine for any particular embodiment of the present invention, and based on the teachings contained herein, whether a usable correlation exists based on a particular set of experimental data.

In a preferred aspect, the method comprises:

(a) identifying at least one readily measured physical property of fluids comprising combinations of the existing working fluid and the recharging working fluid wherein said physical property reliably correlates to target component concentrations for, and/or to other properties that are not readily measured physical properties of, the working fluid after recharge;

(b) providing a system which contains less than a full charge of the existing working fluid;

(c) adding to the existing working fluid a recharging fluid having at least one property, preferably an environmental property, superior to that property of the existing working fluid;

(d) at least after said adding step (c), measuring said readily measured physical property of the operating fluid in the system; and

(e) based on said measuring step, repeating or not said steps (c) and (d) and/or adjusting at least one system operating parameter.

In another aspect, the method comprises:

(a) providing a system which contains an existing working fluid but less than a full charge of the existing working fluid;

(b) adding to the existing working fluid contained in the system a recharging working fluid having at least one property, preferably an environmental property, superior to that property of the existing working fluid contained in the system;

(c) at least after said adding step (b), measuring a readily measured physical property of the fluid in the system that is reliably correlated to one or more component concentration(s) and/or to other property(ies) that are not readily measured physical properties of the working fluid in the system after said adding step (b);

(d) estimating one or more component concentration(s) and/or other property(ies) that are not readily measured physical properties of the working fluid after said adding step (b) based on said measuring step (c); and

(f) repeating or not said steps (b)-(e) and/or adjusting at least one system operating parameter.

Applicants believe that those skilled in the art will be able, based on the disclosures and teachings contained herein, to select the system operating parameter(s) to be adjusted according to the methods of the present invention. By way of example, one or more of the following operating parameters may be adjusted according to the present methods: expansion valve settings; heat exchanger (including condenser, evaporator, suction line heat exchanger (if present)) operation; compressor operation, and the like.

The present recharging apparatus is useful in recharging systems of the type which contain an existing working fluid but which contains less than a full charge of the existing working fluid, wherein the recharging fluid is different than the existing working fluid. One preferred embodiment of the recharging apparatus of the present invention comprises:

(a) a sampling conduit fluidly connected to a body or stream of fluid representative of the working fluid then in the system; and

(b) a physical property measurement device connected to the sampling conduit and readily measuring a physical property of the fluid received from the sampling conduit. In certain of such embodiments the apparatus also includes means for controlling the amount of recharging working fluid added to said system based at least in part on the measurement made by said physical property measurement device. In other embodiments, the apparatus includes means for adjusting one or more operating parameters based at least in part on the measurement made by said physical property measurement device.

### BRIEF DESCRIPTION OF THE DRAWINGS

FIG. 1 shows a Wheatstone bridge sensor.

FIG. 2 shows the experimentally determined thermal conductivity based on the fraction of N-40 in a mixture of N-40 and R-404A.

FIG. 3 shows the experimentally determined liquid density as a function of N-40 fraction in mixtures of N-40 and R-404A.

FIG. 4 shows the experimentally determined dynamic viscosity as a function of the fraction of N-40 in a mixture of N-40 and R-404A.

FIG. 5 shows the experimentally determined vapor specific heat as a function of N-40 fraction in mixtures of N-40 and R-404A.

FIG. 6 shows the experimentally determined difference of bubble and dew pressure as a function of the fraction of N-40 in a mixture of N-40 and R-404A.

FIG. 7 shows the experimentally determined variation of bubble pressure as a function of the fraction of N-40 in a mixture of N-40 and R-404A for different temperatures.

FIG. 8 shows the experimentally determined mixture glide as a function of the fraction of N-40 in a mixture of N-40 and R-404A.

FIG. 9 is a schematic representation of a recharging apparatus of the present invention.

FIG. 10 shows a schematic representation in which a vapor sample is retrieved from the suction line to a compressor.

FIG. 11 shows a schematic representation of a device for bubble-dew pressure differential measurement.

FIG. 12 shows a comparison of the experimental results as compared to the predicted results for R-404A and the compositions of Example 1 in which various amounts of R-404A have been replaced by an N-40 blend

FIG. 13 shows a comparison of the compositions of R-404A and the compositions of Example 1 in which various amounts of R-404A have been replaced by an N-40 blend.

FIG. 14 shows a schematic representation of a portion of a vapor compression refrigeration system connected to a recharging system.

FIG. 15 shows the experimentally determined thermal conductivity as a function of the fraction of N-40 in a mixture of N-40 and R-404A.

FIG. 16 shows the reduction in indirect emissions (in equivalent kg of CO₂) that will be realized when operating with various amounts of R-404A replaced by an N-40 blend compared to what would have been predicted as the lowest indirect impact.

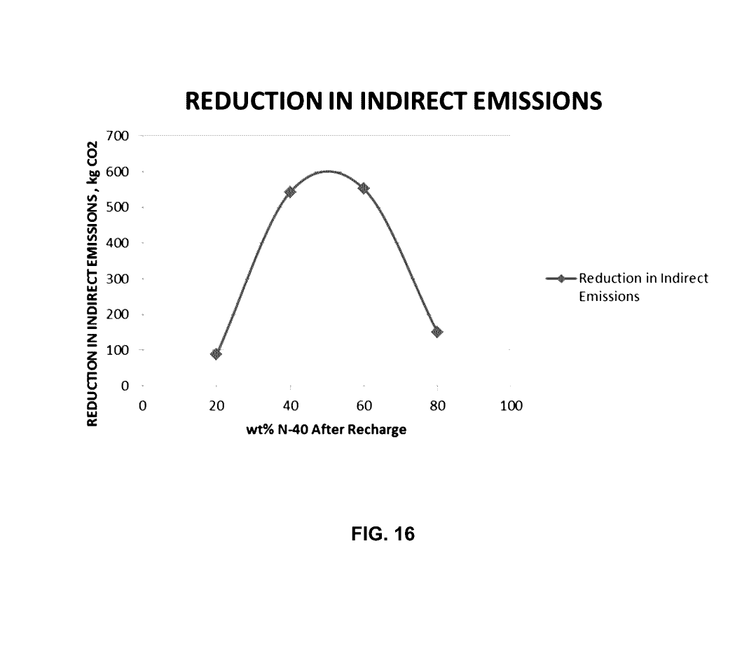

### DETAILED DESCRIPTION

As used herein, the term “readily measured physical property” refers to a physical property of fluids that can be measured in real time or near real time.

As used herein, the term “measured in real time” means that the time between sampling of the fluid and having a measurement value is less than about 5 minutes.

As used herein, the term “measured in near real time” means that the time between sampling of the fluid and having a measurement value is less than about 10 minutes.

The methods and devices disclosed herein are useful for providing improved systems of the type which contain working fluids, and particularly multi-component working fluids, that are periodically required to be recharged. Those skilled in the art will appreciate that many systems utilize a working fluid which is essential to the operation of the system, frequently by circulating through or being transported between various portions of the system, and it is contemplated that all such systems can be recharged according to the methods and using the devices and recharging systems of provided herein.

In certain embodiments, the operating systems which are to be recharged, will have one or more sampling points, ports or the like which will provide a sample representative of the fluid circulating in the system at the time. Such a sampling point or port can exist in or be formed in a reservoir, hold tank, sump or the like, or in a conduit or line through which working fluid flows and from which working fluid is drawn when the system is in operation. When the system is not in operation, in many systems the reservoir, hold tank or sump will contain substantially all of the working fluid in the system such that during shut-down procedures the composition of the working fluid in the hold tank will generally be representative of the composition of the working fluid contained in the system. Thus, the methods provided herein can generally be practiced while the system is shut down, while the system is in operation, or both.

Furthermore, in many or most of systems which contain a working fluid to be recharged according to the methods and systems described, means will be provided or included in the operating system for permitting the operator (including, e.g., a recharge technician) to determine whether the charge of working fluid in the system is below the normal operating level. For example, a sight glass could be used in certain of such systems to allow the operator to visually inspect whether the operating fluid charge is in a region that requires recharging. Based upon this information, or similar information if different means are used, it will be determined that a sufficient amount of the working fluid has either leaked from or otherwise been removed from the system to make it desirable and/or required for the working fluid in the system to be brought back to full charge.

However, as explained in more detail hereinafter, recharging an operating system with fluid different from the existing working fluid will change the components contained in the system and/or the amounts of the components, such changes being variable depending on the amount of recharging fluid added. Applicants have importantly found that while these changes in general can be made with the goal of producing an improvement in one desired property, for example, lowering the GWP of the working fluid by using a recharging fluid with a GWP lower than the GWP of the existing working fluid, such changes may in certain cases have an impact on one or more other properties that are not readily measured and said impact being not intended or desired, including but not limited to deterioration of system performance (e.g., reduced COP and capacity, or increased fluid flammability, etc.), depending upon the relative concentrations of the components in the system once the existing working fluid and the recharging working fluid have been combined in a given proportion. Thus, in many cases an important advantage in recharging operations, and also in system operations generally even if not associated with recharging operations, can be achieved by having a reliable estimate, preferably in real time or in near real time, of the concentration and amounts of the components contained in the system by using a measuring device according to the present invention. For recharging operations these measurements are preferably taken as the system is being recharged and/or after the system has been recharged. Based on the measurement(s) thus obtained, the present methods preferably include adjusting one or more recharging operating parameters to achieve a desired balance of improved properties and avoidance of negative impacts for the working fluid in the system and/or, especially in cases not involving recharging operations, adjusting one or more system operating parameters to accommodate the changes in fluid properties and/or improve system operating performance compared to operating the system with the old operating parameters.

### Recharging Methods

Identifying Readily Measured Physical Property

As mentioned above, one step according to preferred embodiments of the methods of the present invention is to identify a readily measured physical property of the fluid that will be formed upon combination of the original working fluid and various amounts of the recharging working fluid. Based on the teachings contained herein, those skilled in the art will be able to readily identify one or more readily measured physical properties of the fluid which provides a reliable correlation across the spectrum of possible existing fluid/recharging fluid combinations of interest to one or more component concentration(s) of the components in the combined fluids and/or to other property(ies) that are not readily measured physical properties of the combination of fluids. In this way, the methods of the present invention permit the system operator and/or an automatic control device to control the amount of recharging fluid added to achieve the desired balance of improved properties and avoidance of negative properties and/or consequences and/or to control and/or adjust one or more of the operating parameters of the system to achieve improved system operation with working fluid that exists in the system, either during normal system operation or after a recharging operation has been performed.

Generally speaking, the existing working fluid will contain one or more components in concentrations that are generally known to the system operator, and the recharging fluid will also contain one or more components in concentrations that are known to the system operator. For example, in the case of an existing refrigeration system, the system operator will generally know the identity of the existing refrigerant, and thus the components of the refrigerant and the general amounts of those components. The composition of the recharging refrigerant will also be known. Based upon this information, various mixtures and combinations of the existing working fluid and the recharging working fluid can be formed in a manner representative of the possible compositions that will be formed upon recharging according to the present methods and apparatus. For example, various mixtures of the recharging refrigerant and the refrigerant that is the existing refrigerant can be prepared. These mixtures can then be evaluated for a physical property that is correlated to the mixture composition.

Those skilled in the art will then be able, in view of the teachings contained herein, to evaluate a variety of physical properties for each of such combinations (for example, of an existing refrigerant and a recharging refrigerant) and determine if a reliable correlation exists between the concentration of two or more of the components that are in the system, or between some other, non-readily measurable property (physical or otherwise) of the combined fluids and such readily measured physical property. Accordingly, for multiple combinations of the existing working fluid and the recharging working fluid, one or more readily measurable physical properties can be measured as a function of the relative amount of the existing working fluid and the recharging working fluid. By way of non-limiting example, the following physical properties are generally readily measurable, as that term is used in the present application, and can be readily evaluated by those skilled in the art in view of the teachings contained herein:
characteristic pressures, such as bubble point and dew point pressures;
characteristic temperatures, such as bubble point, dew point and temperature glide;
thermal conductivity;
density;
viscosity; and
specific heat.

Based on the teachings contained herein, including the examples provided below, those skilled in the art will be able to select one or more of the above-noted readily measured physical properties and/or other readily measured physical properties for use according to the methods and apparatus of the present invention as providing a reliable correlation as described herein.

By way of non-limiting example, the following provides a description of certain preferred identification steps associated with a refrigeration system containing an existing working fluid know as R-404A and a recharging fluid termed N-40. The compositions of these known fluids, together with the known GWP of each fluid, which is not a readily measured physical property of the fluid, is provided in Table A below:

TABLE A
COMPOSITIONS OF R-404A AND N-40

| COMPONENT | WT % IN R-404A | WT % IN N-40 |
|---|---|---|
| R-32 | 0 | 26 |
| R-125 | 44 | 26 |
| R-134a | 4 | 21 |
| R-143a | 52 | 0 |
| transHFO-1234ze | 0 | 7 |
| HFO-1234yf | 0 | 20 |
| GWP | 3943 | 1273 |

As can be seen from the table above, N-40 has a much lower GWP than R-404A, and therefore is a preferred fluid based exclusively on the GWP of the working fluid. In order to identify a readily measured physical property that is reliably correlated with the amount of N-40 in a given combination with R-404A, a series of compositions comprising N-40 in 5% increments beginning with 5% N-40 and ending with 95% is formed. Based on this series of compositions, the following readily measured physical properties of the compositions are evaluated: thermal conductivity; density; viscosity; specific heat; difference in bubble and dew pressure; bubble point pressure and temperature glide.

Thermal Conductivity

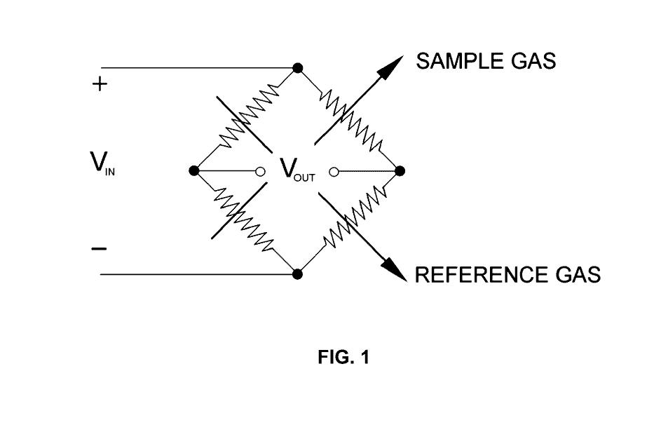

The thermal conductivity of the vapor phase of each composition is determined. For example, the thermal conductivity of an existing refrigerant composition, a recharging refrigerant composition and various mixtures of the recharging refrigerant and the refrigerant that is the existing refrigerant are each measured. In this way, the thermal conductivity as a function of the relative composition of an existing refrigerant and a recharging refrigerant can be evaluated. In preferred embodiments, the procedure to measure the thermal conductivity, which is also the preferred procedure that will be used in the recharging operation, comprises obtaining a liquid sample of the composition and fully vaporizing the liquid sample to obtain a vapor sample with substantially the same combination of components as the liquid mixture. The method which involves substantially fully vaporizing the sample avoids the possibility of having a vapor sample that has a different composition from the liquid sample as a result of fractionation. This vapor sample is introduced into a sensor that determines the thermal conductivity of the fluid in the vapor phase. In preferred embodiments the sensor comprises a Wheatstone bridge as shown in the FIG. 1.

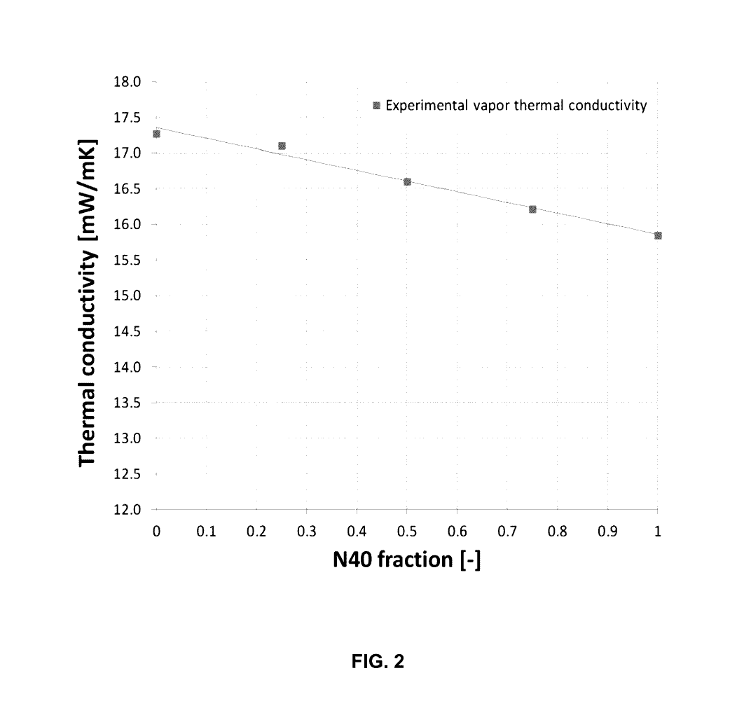

The thermal conductivity measurement is preferably taken at ambient conditions for temperature and pressure. The accuracy of the pressure measurement is preferably within ±0.05 psi and the accuracy of the temperature measurement is preferably within ±0.5 F. Each of the samples has its thermal conductivity measured, and values are then shown to be reliably correlated to the percentage of N-40 in the composition as shown in FIG. 2.

These results show that the thermal conductivity as a function of the fraction of N-40 in a mixture of N-40 and R-404A can provide a calibration plot that can be used to correlate the thermal conductivity of a sample from an operating system having some combination of N-40 and R-404A such that the composition of the sample can be reliably estimated based on the readily measured physical property of thermal conductivity due to its linear relationship over the full range of possible concentrations.

Density

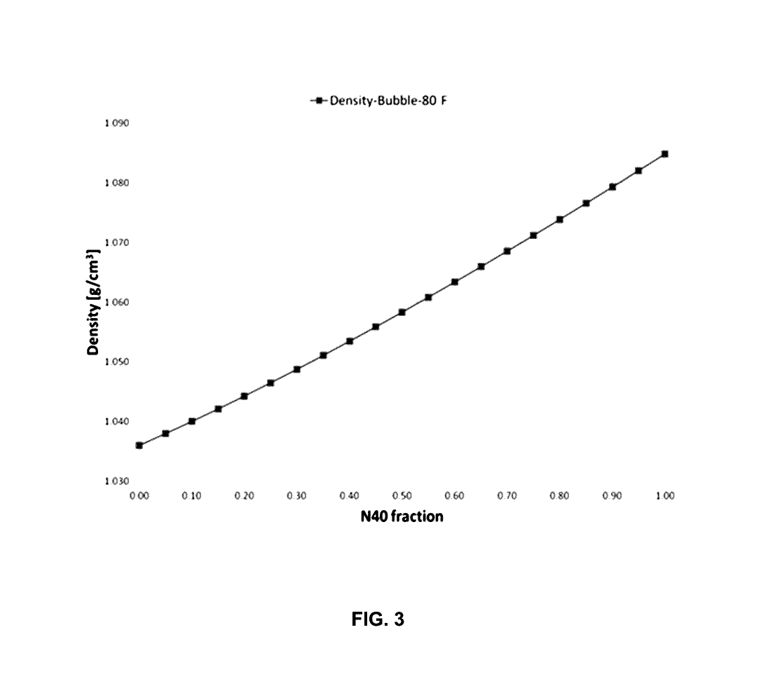

Another readily measured physical property that is evaluated is the density of each of the samples. For example, the density of an existing refrigerant composition, a recharging refrigerant composition and various mixtures of the recharging refrigerant and the refrigerant that is the existing refrigerant are each measured. In this way, the density as a function of the relative composition of an existing refrigerant and a recharging refrigerant can be evaluated. Preferably the density of each composition is measured by placing a sample of the liquid in a 900 cm³ cylinder having a known mass when empty. The pressure in the vessel is measured under ambient temperature, which is also measured. The accuracy of the pressure measurement is preferably within ±0.05 psi and the accuracy of the temperature measurement is preferably within ±0.5 F. The mass of the cylinder filled with the sample is determined using a precision scale with 0.1 g resolution, and the liquid density is determined for each sample. The results are shown in FIG. 3.

Based on this evaluation of the density as a function of the fraction of N-40 in a mixture of N-40 and R-404A, which provides a calibration plot that can be used to correlate density of a sample from an operating system, it is determined that the fraction of N-40 in a mixture of N-40 and R-404A can be reliably estimated based on the readily measured physical property of liquid density due to its substantially linear relationship over the full range of possible concentrations.

Viscosity

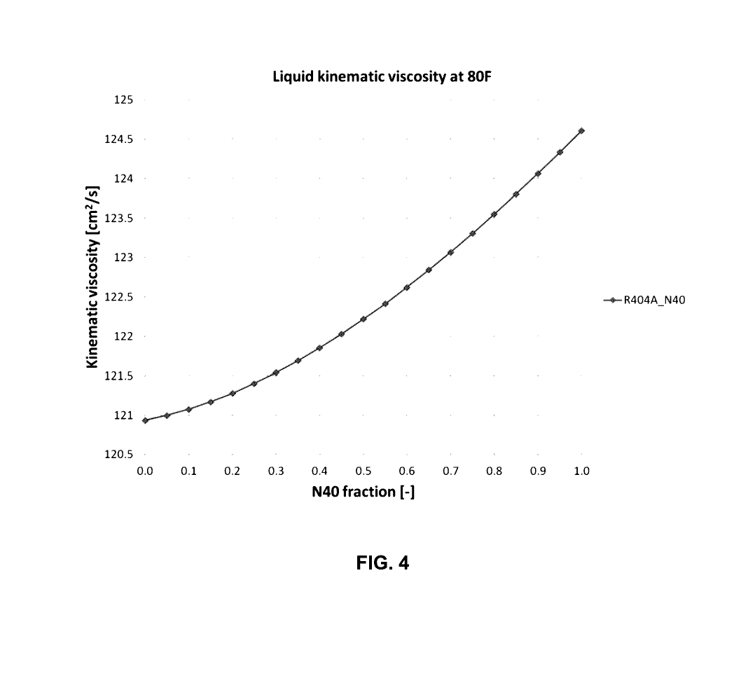

Another readily measured physical property that is evaluated is the viscosity of each of the samples. For example, the viscosity of an existing refrigerant composition, a recharging refrigerant composition and various mixtures of the recharging refrigerant and the refrigerant that is the existing refrigerant are each measured. In this way, the viscosity as a function of the relative composition of an existing refrigerant and a recharging refrigerant can be evaluated. Preferably the viscosity of each composition is measured by placing a sample into a viscosity sensor which measures the viscosity by moving a piston back and forth magnetically at a constant force and wherein the travel time of the piston represents the absolute viscosity for the given temperature. The results are shown in FIG. 4.

Based on this evaluation of the viscosity as a function of the fraction of N-40 in a mixture of N-40 and R-404A, which provides a calibration plot that can be used to correlate viscosity of a sample from an operating system, it is determined that the fraction of N-40 in a mixture of N-40 and R-404A can be reliably estimated based on the readily measured physical property of dynamic viscosity due to its substantially linear relationship over the full range of possible concentrations.

Specific Heat

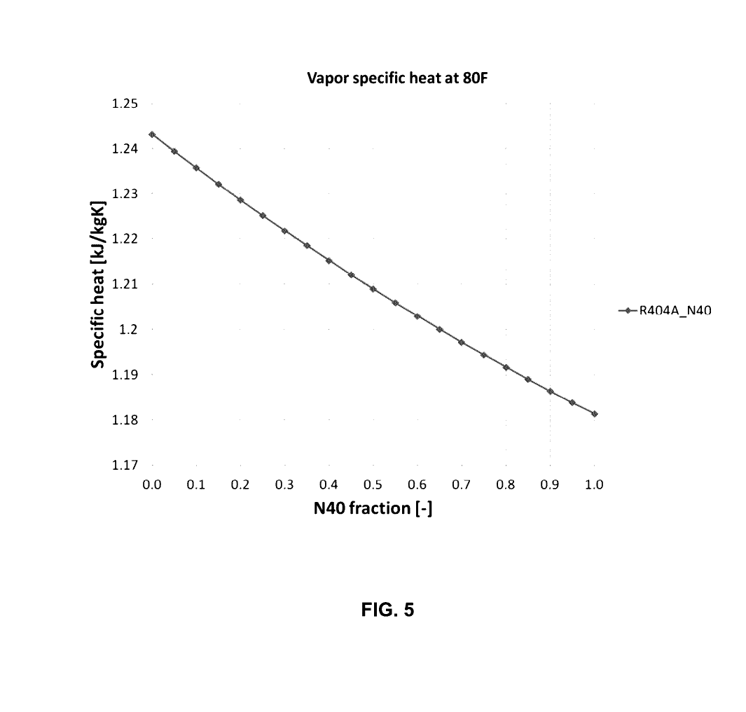

Another readily measured physical property that is evaluated is the specific heat. For example, the specific heat of an existing refrigerant composition, a recharging refrigerant composition and various mixtures of the recharging refrigerant and the refrigerant that is the existing refrigerant are each measured. In this way, the specific heat as a function of the relative composition of an existing refrigerant and a recharging refrigerant can be evaluated. A liquid sample of each of the samples is obtained and fully vaporized to obtain a vapor sample with substantially the same combination of components as the liquid mixture. A sensor is provided which causes the vapor of known mass to flow through a conduct having a specific heat input and which measures the inlet temperature of the sample (that is, prior to any heat input) and the outlet temperature of the sample (that is the temperature after the predetermined amount of heat is added to the sample). Based on the measured temperature difference, the specific heat is determined by dividing the known amount of heat by the measured temperature difference and the known amount of fluid mass flow. The results shown in FIG. 5.

Based on this evaluation of the specific heat as a function of the fraction of N-40 in a mixture of N-40 and R-404A, which provides a calibration plot that can be used to correlate specific heat of a sample from an operating system, it is determined that the fraction of N-40 in a mixture of N-40 and R-404A can be reliably estimated based on the readily measured physical property of specific heat due to its substantially linear relationship over the full range of possible concentrations.

Bubble-Dew Pressure Difference

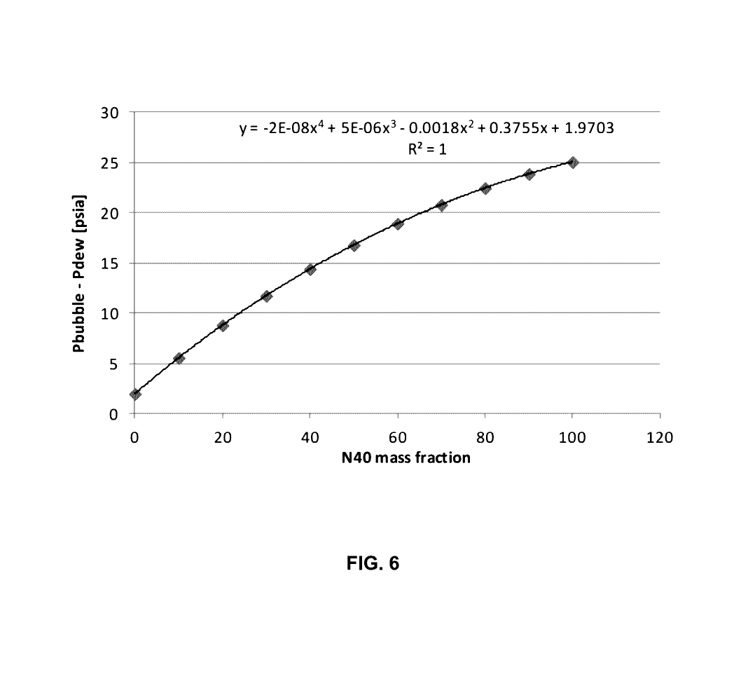

Another readily measured physical property that is evaluated is the difference between the bubble point pressure and the dew point pressure. For example, the difference between the bubble point pressure and the dew point pressure of an existing refrigerant composition, a recharging refrigerant composition and various mixtures of the recharging refrigerant and the refrigerant that is the existing refrigerant are each measured. In this way, the difference between the bubble point pressure and the dew point pressure as a function of the relative composition of an existing refrigerant and a recharging refrigerant can be evaluated. It is generally known that as a zeotropic mixture of components expands from saturated liquid to saturated vapor in a constant temperature process, the pressure that is exerted by a sample composition will decrease from bubble to dew pressure. The pressure difference from bubble point to dew point is measured for each sample, and the results are shown in FIG. 6.

Based on this evaluation of the difference between bubble point pressure and dew point pressure as a function of the fraction of N-40 in a mixture of N-40 and R-404A, which provides a calibration plot that can be used to correlate the difference between bubble point pressure and dew point pressure of a sample from an operating system, it is determined that the fraction of N-40 in a mixture of N-40 and R-404A can be reliably estimated based on the readily measured physical property of difference between bubble point pressure and dew point pressure. Although the relationship shows a slight curvature, the correlation is considered to be reliable over the entire range of concentrations because a unique concentration value can be determined for each value of pressure difference.

Bubble Point Pressure

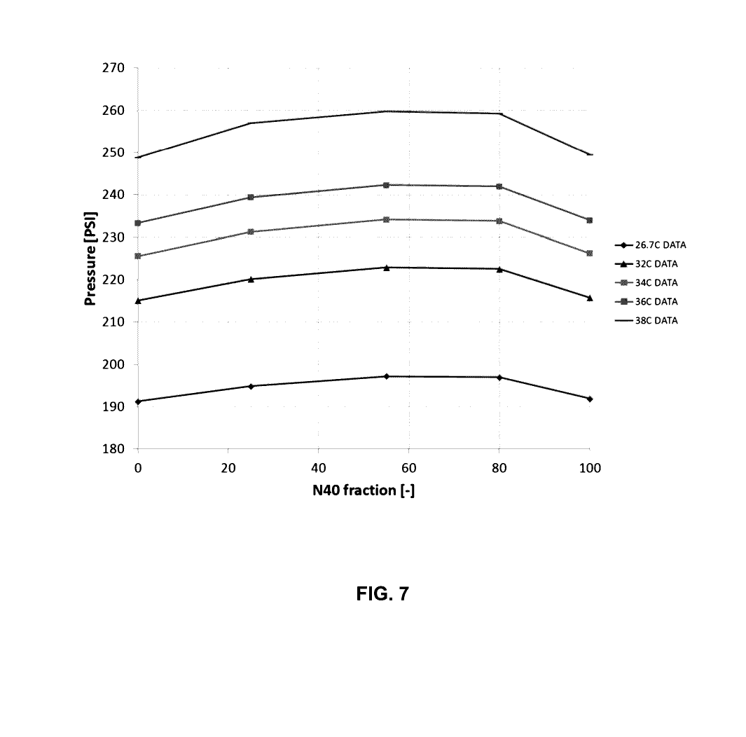

Another readily measured physical property that is evaluated is bubble point pressure of the fluid. For example, the bubble point pressure of an existing refrigerant composition, a recharging refrigerant composition and various mixtures of the recharging refrigerant and the refrigerant that is the existing refrigerant are each measured. In this way, the bubble point pressure as a function of the relative composition of an existing refrigerant and a recharging refrigerant can be evaluated. In order to evaluate this property, each sample is placed in a 900 cm³ cylinder in an amount to fill the cylinder to at least 80% by volume with liquid in order to ensure that the pressure in the cylinder is close to bubble pressure. The pressure in the vessel is measured at series of temperature conditions. The pressure is preferably measured within ±0.05 psi and the accuracy of the temperature measurement is preferably within ±0.5 F. The results are shown in FIG. 7.

As can be seen from the above evaluation, bubble point pressure cannot be reliably used to estimate component concentration over the entire range of possible concentrations since the relationship over this range is shown to be parabolic, which will not provide a unique value of concentration for each value of bubble-point pressure. However, for those methods in which it is known that only a small range of possible concentrations will be used in the recharging operation, this readily measured value can be used. For example, if a recharging operation will be carried-out in which it is known that only mixtures containing less than about 50% of N-40 will result from a recharge operation (such as might be the case in which only relatively little of the recharging refrigerant will be added), the bubble pressure can used. In an alternative embodiment it may be desired to use the bubble pressure measurement in combination with one or more other readily measured physical properties which together permit a reliable estimate of the concentration over the entire concentration range.

Mixture Glide

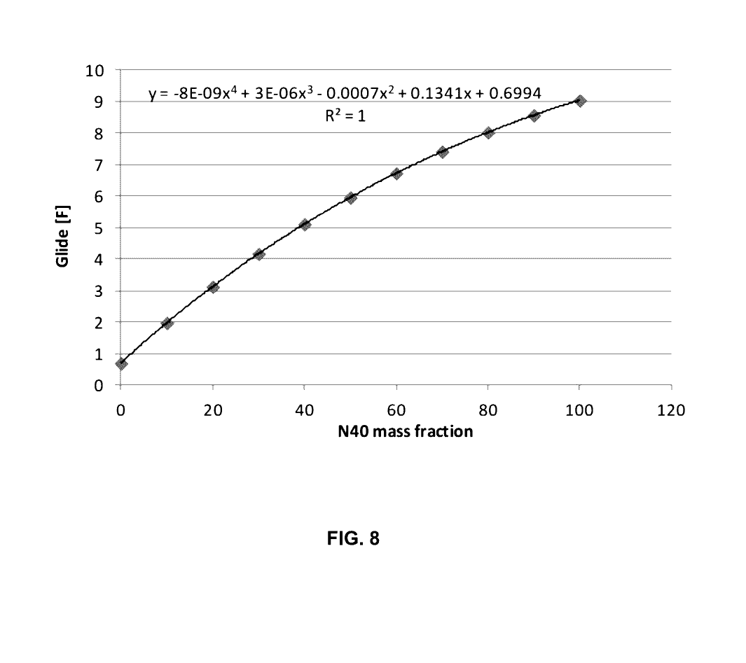

The glide of a mixture of components is measured by boiling a multi-component composition in a constant pressure process and measuring the temperature change. The glide of an existing refrigerant composition, a recharging refrigerant composition and various mixtures of the recharging refrigerant and the refrigerant that is the existing refrigerant are each measured. In this way, the glide as a function of the relative composition of an existing refrigerant and a recharging refrigerant can be evaluated based on experimental data. The “glide” is the difference between the dew point temperature of the vapor and the bubble point of the liquid, and the glide for each composition is measured and the results shown in FIG. 8.

Based on the experimental data and this evaluation of the glide as a function of the fraction of N-40 in a mixture of N-40 and R-404A, which provides a calibration plot that can be used to correlate the glide of a sample from an operating system, it is determined that the fraction of N-40 in a mixture of N-40 and R-404A can be reliably estimated based on the readily measured physical property of mixture glide. Although the relationship shows a slight curvature, the correlation is considered to be reliable over the entire range of concentrations because a unique concentration value can be determined for each value of glide.

Providing a System with Less than a Full Charge of Working Fluid

As described above, it is contemplated that the methods and apparatus as described herein will generally be applied to an operating system that includes a means or mechanism, or can be modified to contain a means or mechanism, that permits or provides a determination that the operating fluid in the system is at a level below the level of full charge. This determination may be made manually, as by observation of a gauge or similar device by a person working with or on the system, or automatically, as would be the case for example in the case where a signal representative of the system charge level as part of a control system.

It is preferred that such systems also include or are modified to include a means or mechanism, such as a sampling port, line or conduit, that permits relatively small samples of the working fluid that are representative of the concentration of at least two of the components of the working fluid that is circulated in or otherwise is transported between different parts or portions of the system. In certain preferred embodiments the sample is removed from the working fluid system reservoir.

It is also preferred that the system includes or is modified to include a means or mechanism to introduce a recharging working fluid into the system, preferably into the working fluid reservoir. For example, the system can include a recharge nozzle positioned to introduce the recharging fluid into the system, preferably at a location which will introduce the recharging fluid into a fluid body that comprises a major proportion of, and preferably substantially all of, the existing working fluid then in the system, preferably into the system working fluid reservoir.

Adding Recharging Fluid to the System

It is contemplated that the step of adding the recharging fluid to the system can take many forms and be carried-out according to techniques known to those skilled in the art, and all such specific forms and techniques are useful in connection with the present methods and devices. The recharging fluid is held in a container, and preferably in certain aspects in a movable or portable container, that is located near or, in the case of portable containers, is brought near the point or portion of the system that has a nozzle or other means for introducing recharging fluid into the system. The step will also in preferred embodiments comprise transporting an amount of the recharging fluid from the container to the recharging nozzle, preferably through a conduit fluidly connecting them. The recharging fluid can be pumped through the conduit or in some embodiments the container is maintained under pressure and is transported to the recharging nozzle as a result of this pressure differential.

The amount of the recharging fluid to be added will depend on the particulars of each system and can be appropriately selected by those skilled in the art in view of the teachings contained herein. However, it is generally believed that in embodiments in which the recharging rate is adjusted to control the concentration of the components in the working fluid after the recharge, the amount and rate at which the recharging fluid is added will be sufficient to allow at least one measuring step of the present invention to be completed prior to the system becoming fully charged. For embodiments in which one or more system operating parameters are adjusted based on the concentration of the working fluid after recharging has been completed, it will not be necessary to conduct a measurement step until after the recharging operation is complete, and in such case it is not generally preferred or necessary that more than one measurement step is carried out, although in such cases multiple measurement steps may be carried out prior to the adjusting step in an effort to check or improve the measured value.

For embodiments in which the working fluid concentration is being controlled to a target value and the adding step is conducted in batch-wise mode, it is preferred that at least two separate adding steps are performed, and it is preferred that the first adding step only recharges a minor percentage of the recharge volume required to achieve a full charge. In this fashion, the second adding step can be guided and or controlled, at least in part, by the results of the first measuring step.

Measuring a Property of the Fluid After an Adding Step

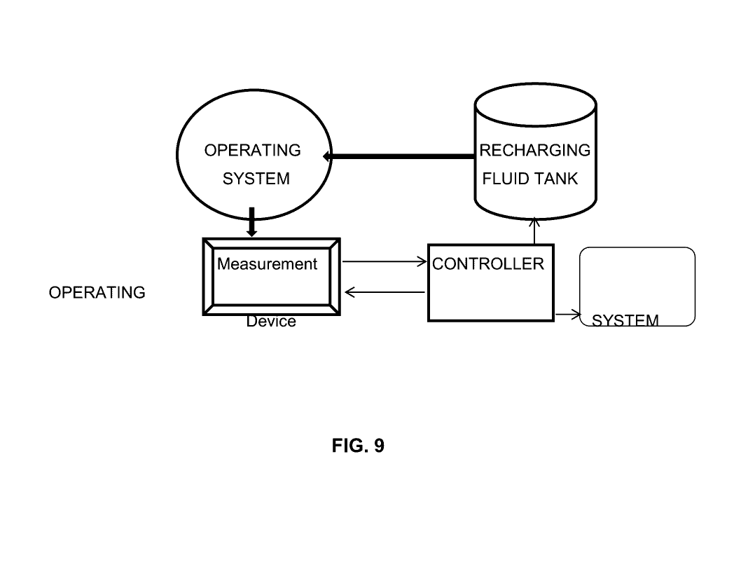

Applicants believe that in general the methods disclosed above in connection with the identification step can be used as described for the measuring step. Generally, the measuring methods can involve batch-wise operations, continuous operations, semi-continuous or combinations of these, and in preferred embodiments the recharging apparatus of the present invention, including the measurement device, will have a configuration schematically depicted In FIG. 9.

In the configuration depicted schematically in FIG. 9, the measurement device obtains or receives a sample of the operating fluid contained in the system and performs the appropriate measurement in real-time or near real-time. The location at which the sample is taken can vary depending on the particulars of the system and other factors, including whether the measurement is being done in a batch-wise or continuous operation. For batch-wise operations, which are preferably but not necessarily carried out when the system is in the shut-down mode, it is generally preferred that the sample of the fluid is taken from the reservoir or hold tank that contains most and preferably substantially all of the working fluid in the system. For continuous operations, which will generally be used to recharge while the system is in the operating mode, a sample is taken from a location in the system that is representative of the concentration of the components then circulating in the system. For embodiments in which the measurement is carried out while the system is in operation, it is generally preferred that the sample is removed from a conduit or line at relatively low pressure in order to facilitate sampling and in turn to recharge the system through a nozzle or port located at a relatively low pressure area of the system in order to facilitate the adding step.

The controller depicted in the schematic drawing above may comprise, and in preferred embodiments does comprise, a physical device that receives a signal from the measurement device representative of the measured value and includes software and/or hardware that sends a signal to control whether and how much recharging fluid is added to the operating system and/or whether to what extent one or more system operating parameters are adjusted. In addition, the controller optionally includes software and/or hardware that can control the measuring unit to when and whether to acquire another sample for measurement. However, it will be appreciated that in certain embodiments the controller in the form of a physical device is not present and in such embodiments the function of receiving the measurement value (e.g., by means of a gauge on the measurement device) and controlling when and whether recharging fluid is added to the operating system, when and whether a new measurement should be made, and when and whether a system operating parameter is adjusted is a human operator. In either case, the control action will be based at least in part on the correlation described above relating to the measured value and the concentration of components in the system.

It will also be appreciated by those skilled in the art that the recharging tank and its associated conduits need not be present for those methods directed to adjustment of system operating parameters in general.

Specific examples of measurement devices are provided below.

Thermal Conductivity Measuring Device

For batch-wise measurement embodiments, it is generally preferred that a sample be obtained from the system, preferably from the working fluid reservoir and/or sampling point or port, and that the sample is a vapor sample representative of the working fluid then operating in the system. In preferred refrigeration system embodiments, a sampling point is used in the suction line of the compressor since this will provide a vapor sample at relatively low pressure. If a liquid sample is used, steps are preferably taken to avoid potential fractionation of the fluid in the sampling process, which would alter the composition and therefore produce an apparent composition which is different than the actual composition of the working fluid in the system. The liquid sample is then fully expanded, potentially by adding heat to and/or reducing the pressure of the sample, to produce a vapor having the same composition as the liquid. The sample of working fluid vapor is then introduced into a thermal conductivity sensor, preferably but not necessarily limited to a Wheatstone bridge configuration as depicted generally above, and the sensor will output the measured value of the vapor thermal conductivity.

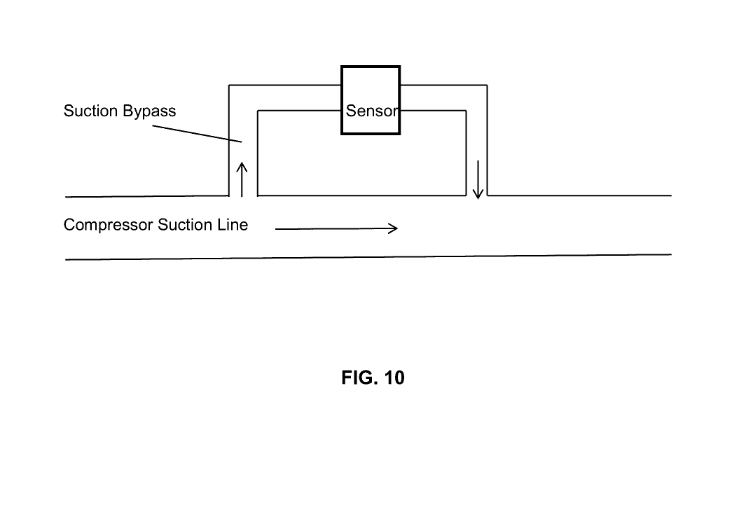

As mentioned above, continuous sampling operations are preferred for some methods while the operating system is in operation, and in many of such operations a relatively low pressure vapor sample is retrieved from the system. In embodiments comprising a vapor compression refrigeration system, the vapor sample is preferably retrieved from the suction line to the compressor. A schematic of a preferred device to retrieving such a sample is provided In FIG. 10.

The sensor is preferably located in a bypass of the suction line to determine the vapor thermal conductivity of the refrigerant mixture. The sensor is preferably installed so as to allow only a minimum, and preferably substantially, no refrigeration oil to reach the sensor. This can be achieved, for example, by utilizing a bypass tube diameter to reduce the refrigerant flow velocity to avoid oil entrainment and/or by using a high density mesh upstream of the sensor to capture oil droplets that are left in the refrigerant flow.

Bubble-Dew Pressure Differential Measurement

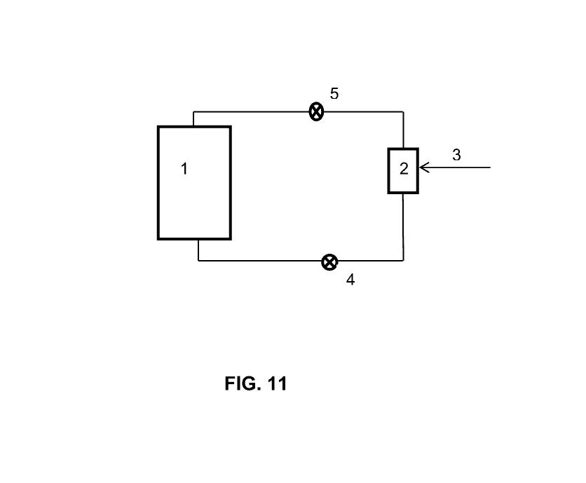

In one preferred embodiment, the measurement device comprises a configuration as illustrated in FIG. 11.

In this preferred embodiment the sample line 3 from the working fluid reservoir brings a sample of working fluid liquid into a relatively small container 2. A valve 4 is used to allow a small portion of the liquid from container 2 to enter the large volume container 1, where the vapor will occupy most of the container. Transducers (not shown) are attached to each container 1 and 2 which provide accurate measurements of the temperature and pressure in each container. Purge valves (not shown) are provided to allow the containers to be evacuated in preparation for receipt of a new fluid sample.

Density Measurement

The density measurement can be determined by any one or more of several techniques. By way of example, a liquid sample is taken and the volume of the liquid is measured (in a graduated cylinder for example), with density being determined by dividing the sample mass by the cylinder volume.

Recharged Systems

The recharged systems of the present invention exhibit one or more improved properties, including and preferably environmental properties, compared to the system with the original charge. In certain cases a portion of the original charge is removed from the system, either intentionally or unintentionally, and should be replaced in order to achieve continued reliable operation of the system. Examples of such systems include, but are not limited to, solvent cleaning systems, such as vapor degreasing systems, and refrigeration systems, such as air-conditioning, low-temperature refrigeration systems and medium-temperature refrigeration systems. Based on the disclosures herein, those skilled in the art will be able to use of the present invention in all such systems in view of the teachings contained herein.

Preferred systems to be recharged using the present methods and devices include medium temperature refrigeration systems. Such systems are important in many applications, such as to the food manufacture, distribution and retail industries, and play a vital role in ensuring that food which reaches the consumer is both fresh and fit to eat. In such medium temperature refrigeration systems, one of the refrigerant liquids which has been commonly used has been HFC-404A, which has an estimated high Global Warming Potential (GWP) of 3943. Applicants have found that a highly desirable but unexpected advantage can be achieved as a result of using certain refrigerant blends, including as part of a system recharge procedure, including substantial environmental advantage and capacity and/or efficiency advantage. More particularly, the preferred aspects of the present invention are directed to the use of a replacement refrigerant comprising, more preferably consisting essentially of, and even more preferably in certain embodiments consisting of (a) from about 10% to about 35% by weight of HFC-32; (b) from about 10% to about 35% by weight of HFC-125; (c) from greater than 0% to about 30% by weight of HFO-1234ze; (d) from about 10% to about 35% by weight of HFC-134a, and (e) from greater than 0% to about 30% by weight of HFO-1234yf. For the purposes of convenience only, but not by way of limitation, refrigerants having components (a)-(e) as described herein are referred to as N-40. The N-40 blend composition refers to the refrigerant composition of HFC-32, HFC-125, HFO-1234ze, HFC-134a and HFO-1234yf that may be used as a replacement refrigerant in existing systems, and particularly used to partially replace R-404A in existing systems. Such compositions are disclosed in detail in provisional application Ser. No. 62/238,481 entitled “Methods and Compositions For Recharging Systems and Recharged Systems,” and filed Oct. 7, 2015, which is incorporated herein by reference.

The abbreviations for the HFC and HFO refrigerants are provided below:

| | |
|---|---|
| Difluoromethane, CH₂F₂ | HFC-32 |
| Pentafluoroethane, CF₃CHF₂ | HFC-125 |
| 1,1,1,2-Tetrafluoroethane, CF₃CH₂F | HFC-134a |
| 1,1,1-Trifluoroethane, CF₃CH₃ | HFC-143a |
| 1,3,3,3-Tetrafluoropropene, | HFO-1234ze |
| CFH═CHCF₃ | |
| 2,3,3,3-Tetrafluoropropene, | HFO-1234yf |
| CH₂═CFCF₃ | |

Unless otherwise indicated herein, HFO-1234ze refers to trans-1234ze.

In one aspect, the N-40 blend comprises (a) from about 20% to about 30% by weight, preferably about 24% to about 27% by weight of HFC-32; (b) from about 20% to about 30% by weight, preferably about 24% to about 27% by weight, of HFC-125; (c) from about 5% to about 20% by weight, preferably from about 5% to about 10% by weight, of HFO-1234ze, (d) from about 15% to about 25% by weight, preferably from about 19% to about 22% by weight, of HFC-134a, and (e) from greater than about 10% to about 25% by weight of HFO-1234yf, preferably from about 15% to about 25% by weight.

In one aspect, the N-40 blend composition comprises (a) from about 20% to about 30% by weight of HFC-32; (b) from about 20% to about 30% by weight of HFC-125; (c) from about 5% to about 20% by weight of HFO-1234ze; (d) from about 15% to about 25% by weight of HFC-134a, and (e) from about 10% to about 25% by weight of HFO-1234yf.

In another aspect, the N-40 blend composition comprises (a) from about 24% to about 27% by weight of HFC-32; (b) from about 24% to about 27% by weight of HFC-125; (c) from about 5% to about 10% by weight of HFO-1234ze; (d) from about 19% to about 22% by weight of HFC-134a, and (e) from about 15% to about 25% by weight of HFO-1234yf.

As the term is used herein, “recharging” refers to methods in which an existing system, including refrigeration and solvent cleaning systems, containing less than a full charge of existing working fluid, such as refrigerant or solvent, respectively, but at least about 25% of a full charge of working fluid, has added thereto a sufficient amount of recharging fluid, such as refrigerant N-40, to produce a system that is fully charged or substantially fully charged.

As used herein, the term “fully charged” means a system, such as a heat transfer or solvent cleaning system, that contains at least the amount of the working fluid (such as refrigerant or solvent) specified for operation of the system and/or at least the amount of working fluid which the system is designed to contain under normal operating conditions. As used herein, the term “substantially fully charge” refers to a system that is at least 90% by weight fully charged. Those skilled in the art should appreciate that the present methods have advantage and utility for recharging of systems that are not fully charged or substantially not fully charged independent of the means or reasons which have resulted in the system being in that condition.

By way of example, in certain embodiments of the present invention it is contemplated that advantages and improvements can be achieved in the operation of existing refrigeration systems by removing a portion of the existing refrigerant, including preferably R-404A, in order to intentionally produce a less than fully charged system according to the present invention. B y way of further example, it is contemplated that in certain situations an existing refrigerant system may be in a less than fully charged condition by reason of leakage or other unintentional depletion of refrigerant from the system. Those skilled in the art, based upon the teachings contained herein, will appreciate that the methods and apparatus of the present invention provide the opportunities for significant and unexpected advantage in either of these circumstances as described more fully below.

### EXAMPLES

The following examples are provided for the purpose of illustrating the present invention but without limiting the scope thereof.

As used herein, the term “medium temperature” system refers to compression refrigeration systems having an evaporator that operates in at least a portion of the range of from about −15° C. to about 0° C., and in certain preferred embodiments the condenser operates at a temperature in at least a portion of the range of from about 20° C. to about 50° C.

As used herein, the term “low temperature” system refers to compression refrigeration systems having an evaporator that operates in at least a portion of the range of from about −40° C. to about −15° C. and a condenser that operates in at least a portion of the range of from about 20° C. to about 50° C.

### Example 1

### Combined Existing and Recharging Refrigeration Fluid with Improved Properties

For Example 1, and for the Examples which follow unless otherwise indicated, medium temperature commercial refrigeration system equipment is used. The system uses a commercially available condensing unit and an evaporator for a walk-in freezer/cooler. The condensing unit is as follows:

a) Manufactured by Keeprite Refrigeration, Brantford, Ontario,

b) Model K350L2 outdoor, air cooled, low temperature, condensing unit equipped with: 460 volts/60 Hz./3 phase electrical,

c) Compressor model 2DF-0300 Copeland compressor, with demand cooling for low temperature conditions, oil separator with solenoid, receiver, two valve flooded head pressure control system, and standard operating controls.

The walk-in cooler is as follows:

a) Manufactured by Keeprite Refrigeration, Model KUCB204DED with electric defrost, low profile DX fed evaporator, with 230 volts/60 Hz./1 phase electrical,

b) Nominal capacity of 17,340 BTUH at −20 deg. F of saturated suction temperature and 10 deg. F air to refrigerant temperature difference and nominal air flow rate of 3,200 CFM air flow,

c) Sporlan distributor and TXV (R-404A designed TXV was used).

The evaporator was installed in an environmentally controlled chamber that served as the walk-in freezer/cooler. The condenser unit was installed in another temperature controlled chamber to maintain the ambient temperature condition. Instrumentation was added to the system to measure refrigerant mass flow rate, refrigerant pressure & temperature before and after each component, air temperature and flow in/out of evaporator and condenser, and power to condensing unit and evaporator.

Tests were run in typical freezer temperatures (35° F.) and typical design ambient condition of 95° F. It should be noted that the refrigerant temperatures were typically 5° F. to 15° F. lower than the chamber temperatures. The evaporator superheat given by the TXV was initially set to 10° F. in the baseline.

The unit was operated with R-404A using a TXV designed for use with R-404A. The results for the system using R-404A are provided in Table CIA below:

TABLE C1A
R-404A SYSTEM OPERATION

| | |
|---|---|
| Evaporator Superheat (F.) | 10.2 |
| Compressor Suction Temperature (F.) | 57.6 |
| Evaporating Temperature (F.) | 24.2 |
| Capacity (% of R-404A) | 100 |
| Efficiency (% of R-404A) | 100 |

Various combinations of R-404A and N-40, containing 20 wt %, 40 wt %, 60 wt % and 80 wt % N-40 (identified as E1, E2, E3 and E4), and 100 wt % N-40 (identified as E5) were then formed and used as the working fluid in this same system. The concentrations of each component which is formed by each of these combinations, together with the results of the test work in terms of Capacity and Efficiency are reported in Table E1A below:

TABLE E1A

| | E1 | E2 | E3 | E4 | E5 |
|---|---|---|---|---|---|
| | | COMPONENT CONCENTRATIONS, WT % | | | |
| HFC-32 | 5.2 | 10.4 | 15.6 | 20.8 | 26 |
| HFC-125 | 40.4 | 36.8 | 33.2 | 29.6 | 26 |
| HFC-143a | 41.6 | 31.2 | 20.8 | 10.4 | 0 |
| HFC-134a | 7.4 | 10.8 | 14.2 | 17.6 | 21 |
| HFO- | 1.4 | 2.8 | 4.2 | 5.6 | 7 |
| 1234ze | | | | | |
| HFO- | 4 | 8 | 12 | 16 | 20 |
| 1234yf | | | | | |
| | | TEST RESULTS | | | |
| Capacity | 105 | 108.5 | 107.5 | 103.5 | 103 |
| (% of R- | | | | | |
| 404A) | | | | | |
| Efficiency | 105.8 | 110.1 | 110.2 | 106.5 | 106 |
| (% of R- | | | | | |
| 404A) | | | | | |

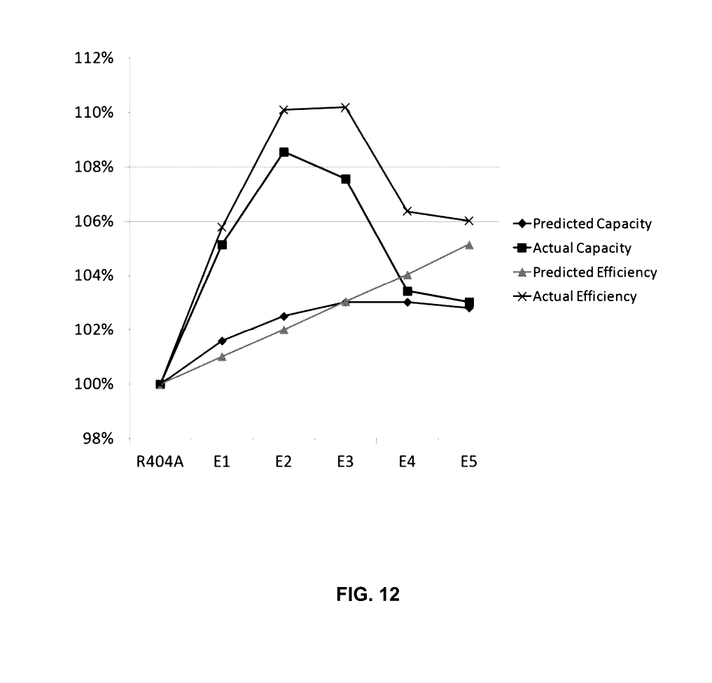

These results, together with results that would have been predicted for these fluids, are shown in FIG. 12.

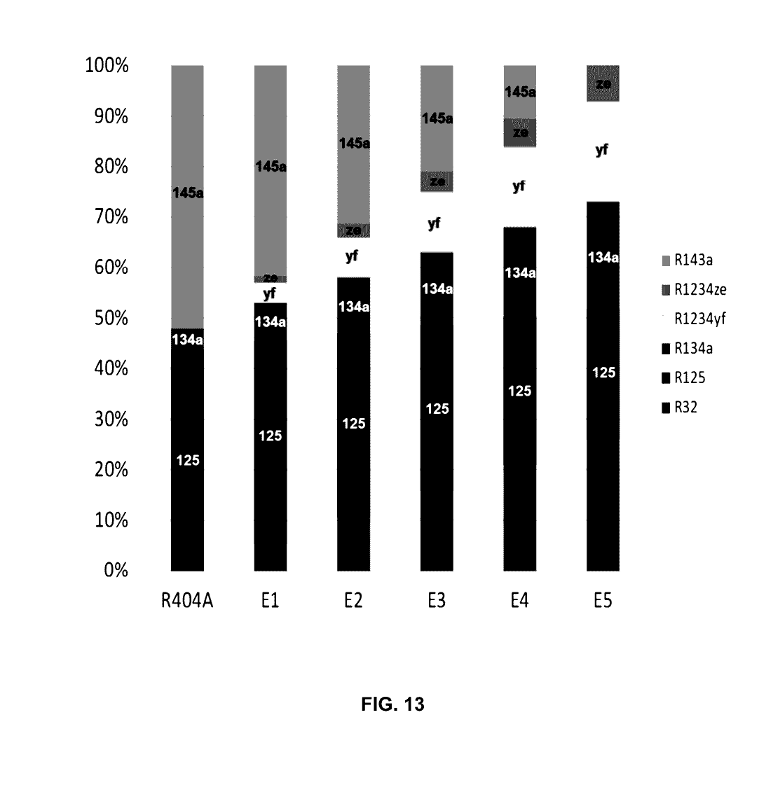

As illustrated in FIGS. 12 and 13, applicants have surprisingly found that neither capacity nor efficiency behaves as predicted for certain concentrations of components and that the variation from the predictions is not only substantial but can also produce highly advantageous operation for a recharged system comprising an amount of N-40 from greater than about 20 wt % to less than about 80 wt %, and most preferably from about 40 wt % to about 60 wt %.

### Example 2

### Refrigeration System Recharging

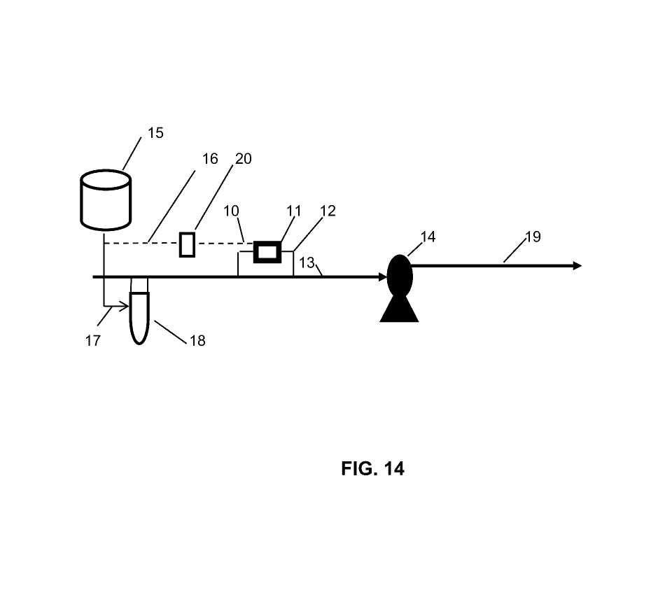

A portion of a vapor compression refrigeration system (components 13, 14, 18, 19) connected to a basic recharging system of the present invention (components 10, 11,12, 15, 16, 17, 20) is provided as illustrated schematically in FIG. 14.

In a system of the type illustrated in FIG. 14, the refrigeration system compressor 14 has a suction line 13 and a discharge line 19. The system has been operating for a period of time with R-404A as the working fluid and during that time an unknown quantity of R-404A has leaked from the system to produce a system that is not fully charged with working fluid. The refrigeration system includes a working fluid reservoir 18 in fluid communication with the suction line 13.

The recharging system comprises a recharging tank 15 containing N-40 refrigerant and a recharging line 17 which has been connected to the reservoir 18. The recharging system also includes suction line bypass conduit(s), sensor 11, control line 11 connected to the sensor and to controller 20, and control line 16 which is connected to a means (not shown) for controlling the amount of recharging N-40 added to the refrigeration system via recharging conduit 17.

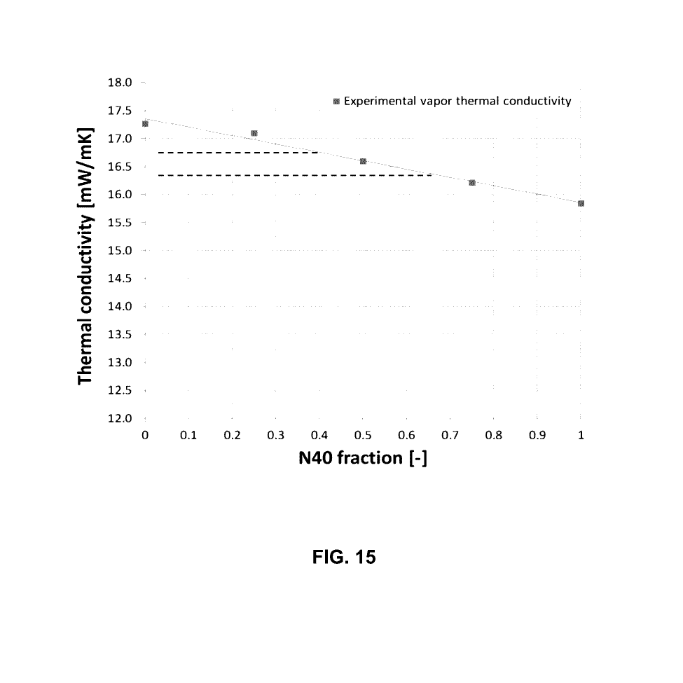

While the refrigeration system is in operation, recharging refrigerant N-40 from recharge tank 15 is slowly but continuously added to reservoir 18 and the vapor in suction line 13 is continuously taken into bypass conduit 12 and continuously introduced in sensor 11, which continuously outputs via line 10 a signal representative of the thermal conductivity of the vapor. The signal from line 10 is received by controller 20 which is preferably a programmable controller having an algorithm reflective of the correlation between vapor thermal conductivity and N-40 wt % as described above and illustrated in FIG. 15.

Based on the algorithm, the controller controls the amount of N-40 added to a thermal conductivity target in the range above about 15.3 and below about 15.6 in order to achieve an N-40 wt % concentration in the preferred range of from about 40 wt % to about 60 wt % while at the same time achieving a system that is recharged within specified parameters.

By conducting a system recharge according to the present invention a substantial and unexpected advantage is achieved. More particularly, by recharging the system according to the present invention the recharged system contains not only a refrigerant with a reduced GWP, but also a system that will operate with unexpectedly improved indirect GWP emissions, as disclosed in the chart below and described more specifically in provisional application Ser. No. 62/238,481 entitled “Methods and Compositions For Recharging Systems and Recharged Systems,” filed Oct. 7, 2015, and which is incorporated herein by reference.

### Examples 3A-3B

Example 2 is repeated except the adding step and the steps subsequent to the measuring step are altered. Specifically, instead of using the measuring step to conduct or not additional adding of the refrigerant during the recharging operation, sufficient recharging refrigerant is added to the system to achieve a substantially fully recharged system. A measurement step is then conducted on a sample representative of the working fluid at substantially full recharge. This measuring step is then used to control and/or adjust one or more system parameters to improve system operation compared to operating the system using the parameters in existence prior to the recharging operation.

### Example 3A

Prior to the recharging operation of the present invention, the system was operating with an evaporation temperature of about −26.5° F. and evaporator superheat of about 10° F., a condensing temperature of about 70° F. and sub-cooling of about 10° F. The addition of N-40 to the system will have an impact on the system capacity and efficiency if no changes in operating parameters are made. For example, for a fixed condensing pressure of 163 psi, the condensing temperature will tend to increase as the working fluid contains increasing amounts of N-40. If no adjustments are made in the system operating parameters, a penalty on the system capacity and efficiency will be realized. Accordingly, one adjustment that can be made to system operating parameters is to adjust the expansion valve to change the condensing pressure based on the estimated component concentrations determined using the readily measured value of thermal conductivity. The possible adjustments to the expansion valve and the improved performance which results from the adjustment are summarized below:

TABLE 3A
Effect of valve adjustment on system performance

| | | Vapor thermal | No adjustment | | | | Adjusted valve | |
|---|---|---|---|---|---|---|---|---|
| | | conductivity at | Condensing | Condensing | Capacity | Efficiency | Condensing | Condensing |
| R404A | N40 | 80 F. | temperature | pressure | penalty | penalty | temperature | pressure |
| [%] | [%] | [mW/mK] | [F.] | [PSI] | [%] | [%] | [F] | [PSI] |
| 100 | 0 | 16.17 | 69.8 | 163 | 0.0% | 0.0% | 70 | 162.6 |
| 80 | 20 | 15.86 | 69.8 | 163 | 0.0% | 0.0% | 70 | 162.6 |
| 60 | 40 | 15.58 | 70.2 | 163 | 0.2% | 0.5% | 70 | 161.6 |
| 40 | 60 | 15.30 | 70.9 | 163 | 0.6% | 1.5% | 70 | 159.8 |
| 20 | 80 | 15.05 | 71.9 | 163 | 1.1% | 2.9% | 70 | 157.4 |
| 0 | 100 | 14.80 | 73.1 | 163 | 1.7% | 4.5% | 70 | 154.5 |

### Example 3B

Prior to the recharging operation of the present invention, the system was operating with an evaporation pressure of 26.7 PSI for an evaporation temperature of about −26.5° F. The addition of N-40 to the system will have an impact on the evaporation temperature. More specifically, the addition of N-40 to the system will tend to cause an increase to the evaporation temperature for a constant pressure setting, and in the case of cooling to provide frozen food products, this can cause damage to the food products. In other words, the system will not be producing the intended or necessary operation and will be considered faulty and/or unreliable. In order to maintain a constant evaporation temperature and to prevent potential damage to the frozen products the system controls can be adjusted according to the present invention as follows:

TABLE 3B
Effect of valve adjustment on evaporation temperature

| Evaporation | | | | | |
|---|---|---|---|---|---|
| pressure | | No adjustment | | Adjusted | |
| 26.7 PSI | | Evaporation | Evaporation | Evaporation | Evaporation |
| R404A | N40 | pressure | temperature | pressure | temperature |
| [%] | [%] | [PSI] | [F.] | [PSI] | [F.] |
| 100 | 0 | 26.7 | −26.5 | 26.7 | −26.5 |
| 80 | 20 | 26.7 | −25.5 | 26.1 | −26.5 |
| 60 | 40 | 26.7 | −24.4 | 25.4 | −26.5 |
| 40 | 60 | 26.7 | −23.2 | 24.6 | −26.5 |
| 20 | 80 | 26.7 | −21.8 | 23.8 | −26.5 |
| 0 | 100 | 26.7 | −20.4 | 23.0 | −26.5 |

### Example 4

Examples 1-3B are repeated except that the recharging fluid, which is sometimes referred to as R-449A, has the following composition:

| R-449A | Wt % |
|---|---|
| HFC-32 | 24.3 |
| HFC-125 | 24.7 |
| HFC-134a | 25.7 |
| HFO- | 25.3 |
| 1234yf | |

The system is recharged and system operation is approved in general in the same manner as indicated above in connection with Examples 1-3B.

### Example 5

Examples 1-3B are repeated except that the recharging fluid, which is sometimes referred to as R-442A, has the following composition:

| R-442A | Wt % |
|---|---|
| HFC-32 | 31 |
| HFC-125 | 31 |
| HFC-134a | 30 |
| HFC-152a | 3 |
| HFC- | 5 |
| 227ea | |

The system is recharged and system operation is approved in general in the same manner as indicated above in connection with Examples 1-3B.

### Example 6

Examples 1-3B are repeated except that the recharging fluid, which is sometimes referred to as R-407A, has the following composition:

| R-407A | Wt % |
|---|---|
| HFC-32 | 20 |
| HFC-125 | 40 |
| HFC-134a | 40 |

The system is recharged and system operation is approved in general in the same manner as indicated above in connection with Examples 1-3B.

### Example 7

Examples 1-3B are repeated except that the recharging fluid, which is sometimes referred to as R-407B, has the following composition:

| R-407B | Wt % |
|---|---|
| HFC-32 | 10 |
| HFC-125 | 70 |
| HFC-134a | 20 |

The system is recharged and system operation is approved in general in the same manner as indicated above in connection with Examples 1-3B.

### Example 8

Examples 1-3B are repeated except that the recharging fluid, which is sometimes referred to as R-407C, has the following composition:

| R-407C | Wt % |
|---|---|
| HFC-32 | 23 |
| HFC-125 | 25 |
| HFC-134a | 52 |

The system is recharged and system operation is approved in general in the same manner as indicated above in connection with Examples 1-3B.

### Example 9

Examples 1-3B are repeated except that the recharging fluid, which is sometimes referred to as R-407D, has the following composition:

| R-407D | Wt % |
|---|---|
| HFC-32 | 15 |
| HFC-125 | 15 |
| HFC-134a | 70 |

The system is recharged and system operation is approved in general in the same manner as indicated above in connection with Examples 1-3B.

### Example 10

Examples 1-3B are repeated except that the recharging fluid, which is sometimes referred to as R-407E, has the following composition:

| R-407E | Wt % |
|---|---|
| HFC-32 | 25 |
| HFC-125 | 15 |
| HFC-134a | 60 |

The system is recharged and system operation is approved in general in the same manner as indicated above in connection with Examples 1-3B.

### Example 11

Examples 1-3B are repeated except that the recharging fluid, which is sometimes referred to as R-407F, has the following composition:

| R-407F | Wt % |
|---|---|
| HFC-32 | 30 |
| HFC-125 | 30 |
| HFC-134a | 40 |

The system is recharged and system operation is approved in general in the same manner as indicated above in connection with Examples 1-3B.

### Example 12

Examples 1-3B are repeated except that the existing fluid, which is sometimes referred to as R-507A, has the following composition:

| R-507A | Wt % |
|---|---|
| HFC-125 | 50 |
| HFC-143a | 50 |

The system is recharged and system operation is approved in general in the same manner as indicated above in connection with Examples 1-3B.

What is claimed is:

1. A method of recharging an operating system comprising:
(a) providing a system which contains an existing working fluid but less than a full charge of the existing working fluid;
(b) adding to the existing working fluid contained in the system a recharging working fluid having at least one property superior to that property of the existing working fluid contained in the system;
(c) at least after said adding step (b), measuring a readily measured physical property of the fluid in the system that is reliably correlated to one or more component concentration(s) of the working fluid in the system after said adding step (b);
(d) estimating one or more component concentration(s) of the working fluid after said adding step (b) based on said measuring step (c); and
(f) repeating or not said steps (b)-(e) and/or adjusting at least one system operating parameter.

2. The method of claim 1, wherein the operating system is a refrigeration system.

3. The method of claim 2, wherein the operating system is a medium-temperature refrigeration system.

4. The method of claim 2, wherein the existing working fluid is an existing refrigerant.

5. The method of claim 2, wherein the existing working fluid comprises R-404A.

6. The method of claim 2, wherein the recharging working fluid is recharging refrigerant composition.

7. The method of claim 6, wherein the recharging working fluid has the composition comprising: (a) from about 10% to about 35% by weight of HFC-32; (b) from about 10% to about 35% by weight of HFC-125; (c) from greater than 0% to about 30% by weight of HFO-1234ze; (d) from about 10% to about 35% by weight of HFC-134a, and (e) from greater than 0% to about 30% by weight of HFO-1234yf, based on the weight of components (a) to (e).

8. The method of claim 6, wherein the recharging working fluid has the composition comprising: (a) from about 20% to about 30% by weight of HFC-32; (b) from about 20% to about 30% by weight of HFC-125; (c) from about 5% to about 20% by weight of HFO-1234ze; (d) from about 15% to about 25% by weight of HFC-134a, and (e) from about 10% to about 25% by weight of HFO-1234yf, based on the weight of components (a) to (e).

9. The method of claim 6, wherein the recharging working fluid has the composition comprising: (a) from about 24% to about 27% by weight of HFC-32; (b) from about 24% to about 27% by weight of HFC-125; (c) from about 5% to about 10% by weight of HFO-1234ze; (d) from about 19% to about 22% by weight of HFC-134a, and (e) from about 15% to about 25% by weight of HFO-1234yf, based on the weight of components (a) to (e).

10. The method of claim 2, wherein the readily measured physical property of the fluid in the system is selected from the group consisting of thermal conductivity, glide, density, viscosity, specific heat, and difference between the bubble point pressure and the dew point pressure.

11. The method of claim 2, wherein the at least one system operating parameter is selected from the group consisting of expansion valve settings, heat exchanger operation, and compressor operation.

12. A recharging apparatus useful in recharging systems of the type which contain an existing working fluid but which contains less than a full charge of the existing working fluid, wherein the recharging fluid is different than the existing working fluid, said apparatus comprising:
(a) a sampling conduit fluidly connected to a body or stream of fluid representative of the working fluid then in the system; and
(b) a physical property measurement device connected to the sampling conduit and readily measuring a physical property of the fluid received from the sampling conduit.

13. The apparatus of claim 12, further comprising means for controlling the amount of recharging working fluid added to said system based at least in part on the measurement made by said physical property measuring device.

14. The apparatus of claims 12, further comprising means for adjusting one or more operating parameters of the system based at least in part on the measurement made by said physical property measurement device.

15. The apparatus according to claim 14, wherein the at least one system operating parameter is selected from the group consisting of expansion valve settings, heat exchanger operation, and compressor operation.

16. The apparatus according to any of claims 12, wherein the working fluid is a refrigerant.

17. The apparatus according to any of claims 12, wherein the physical property of the fluid that is measured by the physical property measuring device is selected from the group consisting of thermal conductivity, glide, density, viscosity, specific heat, and difference between the bubble point pressure and the dew point pressure.

18. An apparatus for improving systems of the type which contain an existing working fluid, said apparatus comprising:
(a) a sampling conduit fluidly connected to a body or stream of fluid representative of the working fluid then in the system; and
(b) a physical property measurement device connected to the sampling conduit and readily measuring a physical property of the fluid received from the sampling conduit; and
(c) means for controlling a system operating parameter in response to output from said measurement device.

19. The apparatus of claim 18, wherein the system is a refrigeration system and the working fluid is a refrigerant.

20. The apparatus of claim 19, wherein the physical property of the fluid that is measured by the physical property measuring device is selected from the group consisting of thermal conductivity, glide, density, viscosity, specific heat, and difference between the bubble point pressure and the dew point pressure.

21. The apparatus of claim 19, wherein the at least one system operating parameter is selected from the group consisting of expansion valve settings, heat exchanger operation, and compressor operation.

22. A method of improving the operation of a system of the type which contains an existing working fluid, the method comprising:
(a) providing a system which contains an existing working fluid;
(b) measuring a readily measured physical property of the fluid in the system that is reliably correlated to one or more component concentration(s) of the working fluid in the system after said adding step (b);
(c) estimating one or more component concentration(s) of the working fluid based on said measuring step (b); and
(d) adjusting at least one system operating parameter based on said estimate.

23. The method of claim 22, wherein the operating system is a refrigeration system.

24. The method of claim 23, wherein the operating system is a medium-temperature refrigeration system.

25. The method of claim 23, wherein the existing working fluid is an existing refrigerant.

26. The method of claim 25, wherein the existing working fluid comprises R-404A.

27. The method of claim 23, wherein the recharging working fluid is recharging refrigerant composition.

28. The method of claim 27, wherein the recharging working fluid has the composition comprising: (a) from about 10% to about 35% by weight of HFC-32; (b) from about 10% to about 35% by weight of HFC-125; (c) from greater than 0% to about 30% by weight of HFO-1234ze; (d) from about 10% to about 35% by weight of HFC-134a, and (e) from greater than 0% to about 30% by weight of HFO-1234yf, based on the weight of components (a) to (e).

29. The method of claim 27, wherein the recharging working fluid has the composition comprising: (a) from about 20% to about 30% by weight of HFC-32; (b) from about 20% to about 30% by weight of HFC-125; (c) from about 5% to about 20% by weight of HFO-1234ze; (d) from about 15% to about 25% by weight of HFC-134a, and (e) from about 10% to about 25% by weight of HFO-1234yf, based on the weight of components (a) to (e).

30. The method of claim 27, wherein the recharging working fluid has the composition comprising: (a) from about 24% to about 27% by weight of HFC-32; (b) from about 24% to about 27% by weight of HFC-125; (c) from about 5% to about 10% by weight of HFO-1234ze; (d) from about 19% to about 22% by weight of HFC-134a, and (e) from about 15% to about 25% by weight of HFO-1234yf, based on the weight of components (a) to (e).

31. The method of claim 23, wherein the readily measured physical property of the fluid in the system is selected from the group consisting of thermal conductivity, glide, density, viscosity, specific heat, and difference between the bubble point pressure and the dew point pressure.

32. The method of claim 23, wherein the at least one system operating parameter is selected from the group consisting of expansion valve settings, heat exchanger operation, and compressor operation.
